(19) United States
(12) Patent Application Publication
(10) Pub. No.: US 2007/0261192 A1
(43) Pub. Date: Nov. 15, 2007

(54) Windscreen Wiper Arm

(76) Inventors: Keith Butcher, Cookeville, TN (US); Marco Gilli, Chieri (IT); Gurdev Orjela, Arlon (BE)

Correspondence Address: DICKINSON WRIGHT PLLC, 38525 WOODWARD AVENUE, SUITE 2000, BLOOMFIELD HILLS, MI, 48304-2970, US

(21) Appl. No.: 10/592,275

(22) PCT Filed: Mar. 1, 2005
(86) PCT No.: PCT/EP05/50898

§ 371 Date: Jul. 23, 2007

(30) Foreign Application Priority Data
Mar. 9, 2004 (EP) 04100961.4

(51) Int. Cl. B60S 1/34

(52) U.S. Cl. 15/250.31

(57) ABSTRACT

A windscreen wiper arm to be mounted on a rear side of a vehicle, particularly an automobile, comprising a mounting head mountable on a drive shaft and an arm member pivotally connected to the mounting head by means of a pivot pin, with the special feature that said windscreen wiper arm is provided with at least one light source.

### CROSS-REFERENCES TO RELATED APPLICATIONS

This patent application claims priority to PCT/EP2005/050898, having an International filing date of Mar. 1, 2005, which claims priority to EP 04100961.4 filed on Mar. 9, 2004, which are incorporated herein by reference in their entirety.

### BACKGROUND OF THE INVENTION

1. Field of the Invention

The present invention relates to a windscreen wiper arm to be mounted on a rear side of a vehicle, particularly an automobile, comprising a mounting head mountable on a drive shaft and an arm member pivotally connected to the mounting head by means of a pivot pin. Particularly, the arm member has a substantially U-shaped cross-section near side pivot pin comprising two side walls, wherein a part of the mounting head extends between the side walls and beyond said pivot pin.

2. Related Art

Such a windscreen wiper arm is generally known. Nowadays for safety reasons automobiles are provided on their rear side with several lights, such as taillights and brakelights, particularly in order to make rear traffic aware of the fact that an automobile participates in traffic (taillights) or that a dangerous road situation may occur due to a braking action (brake lights). Obviously, complex machinery, tools etcetera are needed to equip each type of automobile with such lights, with all the expenses involved.

It is an object of the invention to obviate this disadvantage, in the sense that at minimum costs-without complex machinery and additional tools-each type of automobile can be equipped with taillights and brakelights, and/or with (an) additional light(s).

### SUMMARY OF THE INVENTION

In order to accomplish that objective a windscreen wiper arm mentioned in the preamble according to the invention is characterized in that said windscreen wiper arm is provided with at least one light source. It is the merit of the invention that electrical means already existing in the automobile and enabling the windscreen wiper arm to carry out its oscillating movement, are also used for (a) light(s) at the rear side of the automobile. In other words, (a) light(s) are created on the rear side of an automobile at the location where electrical means, such as electrical supplies, electrical connections etcetera, are already present therein.

In a preferred embodiment of a windscreen wiper arm in accordance with the invention the light source is provided on the arm member. In the alternative, the light source is provided on the mounting head.

In another preferred embodiment of a windscreen wiper arm according to the invention the light source is provided on the mounting head near a mounting location for the drive shaft. This has the advantage that when the windscreen wiper arm carries out its oscillating movement, the light source does not move accordingly, i. e. is stationary.

In another preferred embodiment of a windscreen wiper arm in accordance with the invention the light source is part of a taillight. In the alternative, the light source is part of a brakelight. Particularly, said brakelight is a third brakelight of the automobile.

In another preferred embodiment of a windscreen wiper arm according to the invention the taillight or the brakelight is integrated in the windscreen wiper arm.

The invention refers also to a mounting head and/or an arm member provided with at least one light source as defined in a windscreen wiper arm in accordance with the invention. The invention also relates to a windscreen wiper device comprising a windscreen wiper arm according to the invention. Particularly, said windscreen wiper device comprises an elastic, elongated carrier element, as well as an elongated wiper blade of a flexible material, which can be placed in abutment with a rear windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device comprises a connecting device for the windscreen wiper arm in accordance with the invention.

Finally, the invention also refers to a method for manufacturing a windscreen wiper arm to be mounted on a rear side of a vehicle, particularly an automobile, comprising a mounting head mountable on a drive shaft and an arm member pivotally connected to the mounting head by means of a pivot pin, characterized in that said windscreen wiper arm is provided with at least one light source.

### BRIEF DESCRIPTION OF THE DRAWINGS

The invention will now be explained in more detail with reference to figures illustrated in a drawing, wherein:

FIG. 1 is a perspective, schematic view of a preferred embodiment of a windscreen wiper device equipped with a windscreen wiper arm according to the invention, wherein the windscreen wiper arm is in a wiping position;

FIGS. 2 through 4 show details of the windscreen wiper device of FIG. 1;

FIG. 5 is a bottom view of the windscreen wiper arm of FIG. 1; and

FIGS. 6 and 7 show the windscreen wiper device of FIG. 1 mounted on a rear windscreen of an automobile.

### DETAILED DESCRIPTION OF THE PREFERRED EMBODIMENT

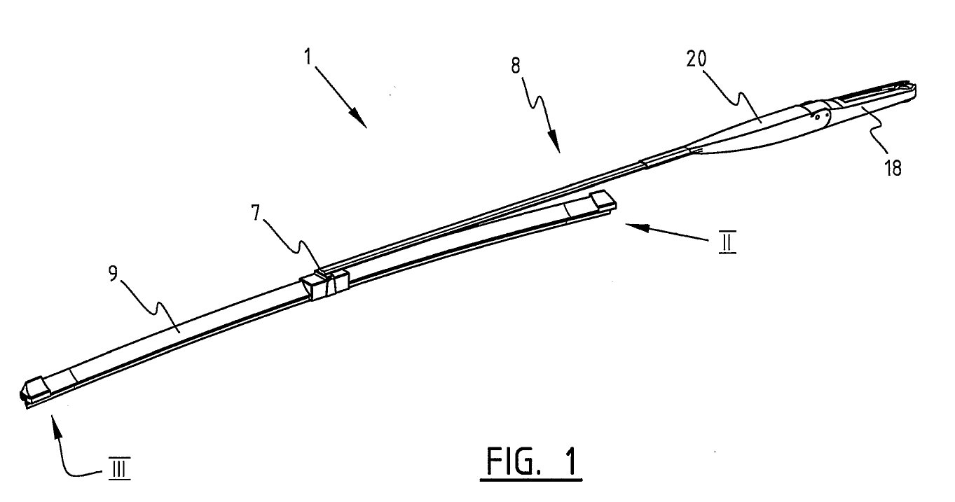

FIGS. 1 through 4 show a preferred variant of a windscreen wiper device 1 according to the invention. Said windscreen wiper device is built up of an elastomeric wiper blade 2, in the longitudinal sides of which opposing longitudinal grooves 3 are formed, and of longitudinal strips 4 made of spring band steel, which are fitted in said longitudinal grooves 3. Said strips 4 form a flexible carrier element for the rubber wiper blade 2, as it were, which is thus biassed in a curved position (the curvature in operative position being that of a windscreen to be wiped). Neighbouring ends 5 of strips 4 are interconnected on either side of the windscreen wiper device 1 by means of connecting pieces 6. The windscreen wiper device 1 is further equipped with a connecting device 7 for an oscillating arm 8, and a spoiler 9.

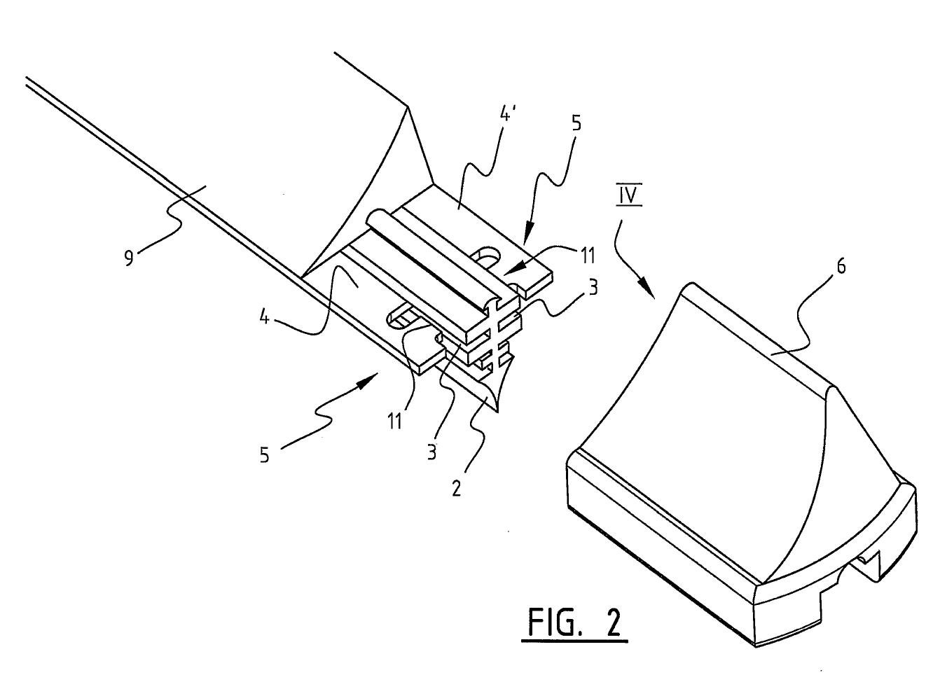

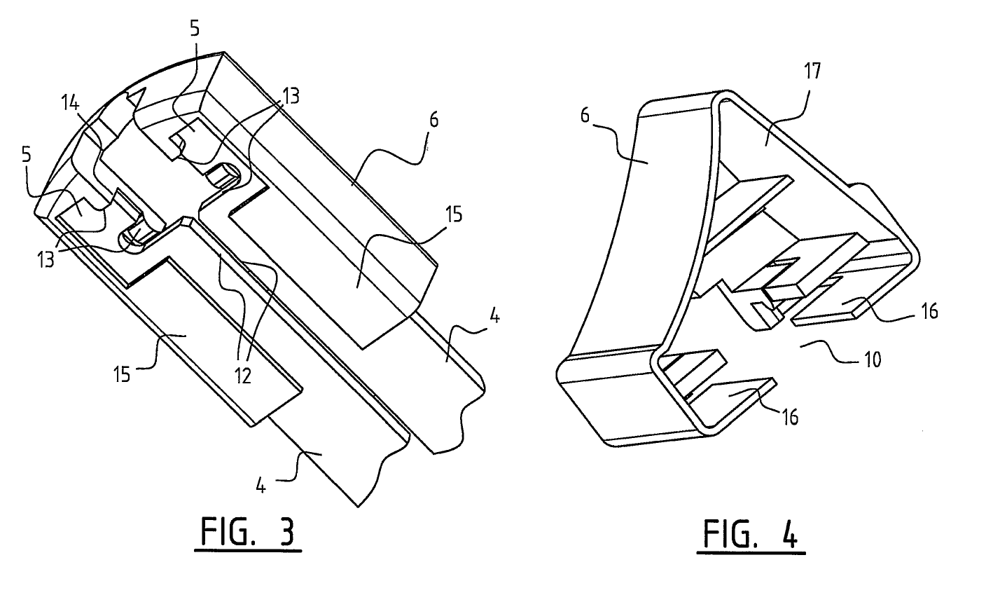

FIGS. 2 and 3 show a free end of the windscreen wiper device 1 of FIG. 1, whereas FIG. 4 reveals a bottom view of said free end without the wiper blade 2 being present. Corresponding parts have been designated with the same reference numerals. As can be seen from FIG. 4 (showing in perspective the connecting piece 6 as a separate constructional element), the connecting piece 6 is provided with an opening 10 in order to allow a relative movement of the wiper blade 2 along the strips 4 inside the connecting piece 6, so that said connecting piece 6 does not block the wiper blade 2 during use. The connecting pieces 6 are made of one piece of plastic.

With reference to FIGS. 2 and 3, said strips 4 are each provided with a protrusion 11 extending laterally from a longitudinal interior edge 12 of the strips 4. When a connecting piece 6 is slidably mounted onto the neighbouring ends 5 of the strips 4, a snap or clicking connection is realized, wherein the protrusions 11 are snapped or clicked between stops 13 (“notches 13”) inside the connecting piece 6. Each protrusion 11 rests in a small groove 14 between these opposing stops 13. Accordingly, the strips 4 are blocked against any movement in longitudinal direction with respect to the connecting pieces 6. Each connecting piece 6 is also provided with two engaging members 15 made integral therewith, wherein said engaging members 15 engage around the strips 4 so as to form a groove 16 for sliding the strips 4 therein. Said engaging members 15 ensure that the strips 4 are blocked against any movement in transversal direction with respect to the connecting pieces 6. Each connecting piece 6 has a cavity 17 to accommodate the free end of the spoiler 9.

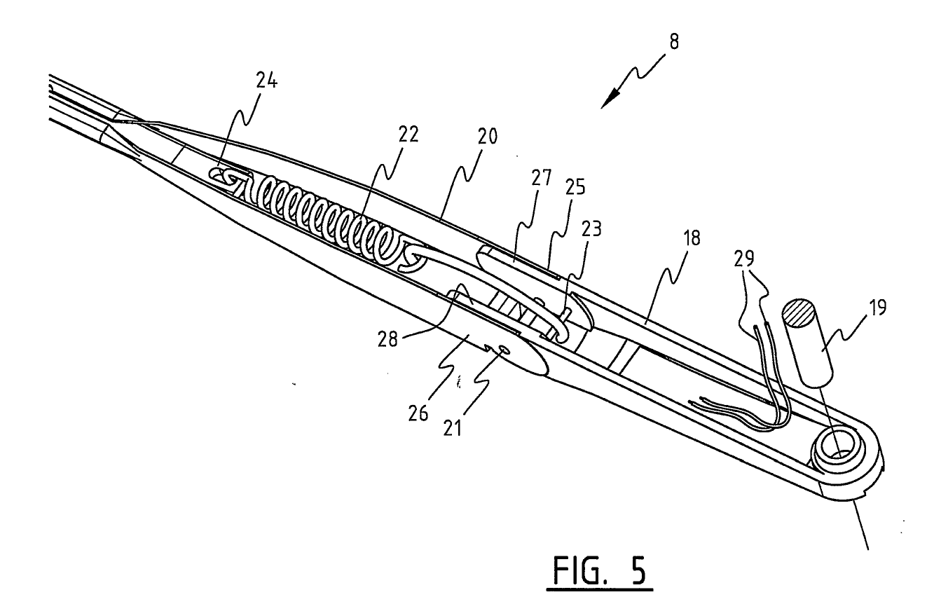

As illustrated in FIG. 5 the windscreen wiper arm 8 according to the invention comprises a plastic mounting head 18 which can be fixed for rotation to a shaft 19 driven, via a mechanism not illustrated, by a small motor. Said windscreen wiper arm 8 further comprises a plastic arm member 20 supported by the mounting head 18, wherein said arm member 20 in turn supports the wiper blade 2 with the help of the connecting device 7, as illustrated in FIG. 1. The arm member 20 is pivotally connected to the mounting head 18 by means of a pivot pin 21. A spring 22 is hooked with its first end on a pin 23 on the mounting head 18 and with its second end on to a part 24 of the arm member 20 in order to ensure that the arm member 20 and thus the wiper blade 2 connected thereto is pressed onto a windscreen to be wiped. In use, the shaft 19 rotates alternately in a clockwise and in a counter-clockwise sense carrying the mounting head 18 into rotation also, which in turn draws the arm member 20 into rotation and by means of the connecting device 7 moves the wiper blade 2.

As illustrated, the arm member 20 has a substantially U-shaped cross-section near said pivot pin 21 comprising two side walls 25,26, wherein a part of the mounting head 18 extends between the side walls 25,26 and beyond said pivot pin 21. Said part is provided with opposite abutting surfaces 27,28 for abutting against the side walls 25,26. Either the mounting head 18 or the arm member 20 or both are provided with a taillight wiring 29 integrated therein. In order to avoid that the taillight carries out an oscillatory motion together with the mounting head 18/arm member 20, it is preferred that the taillight is mounted near the location of the shaft 19.

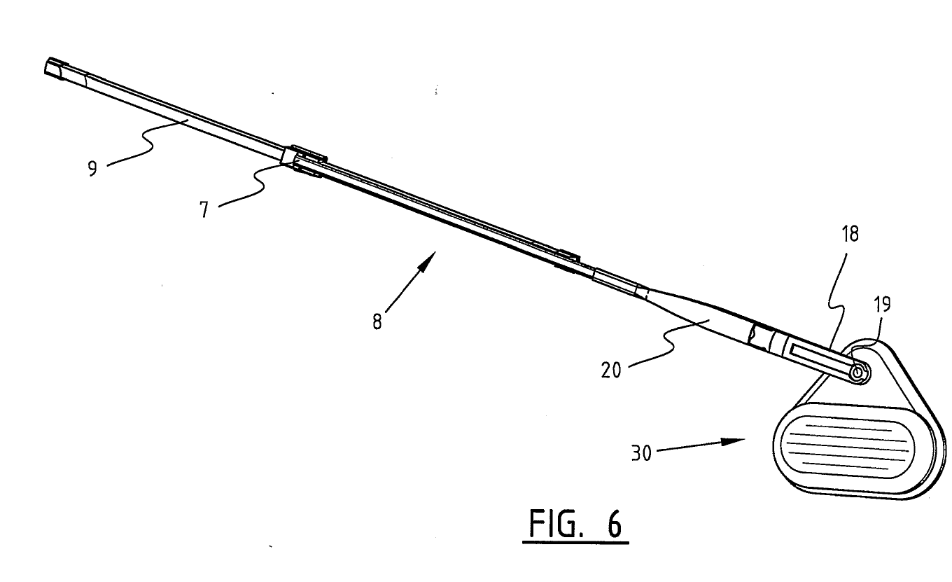

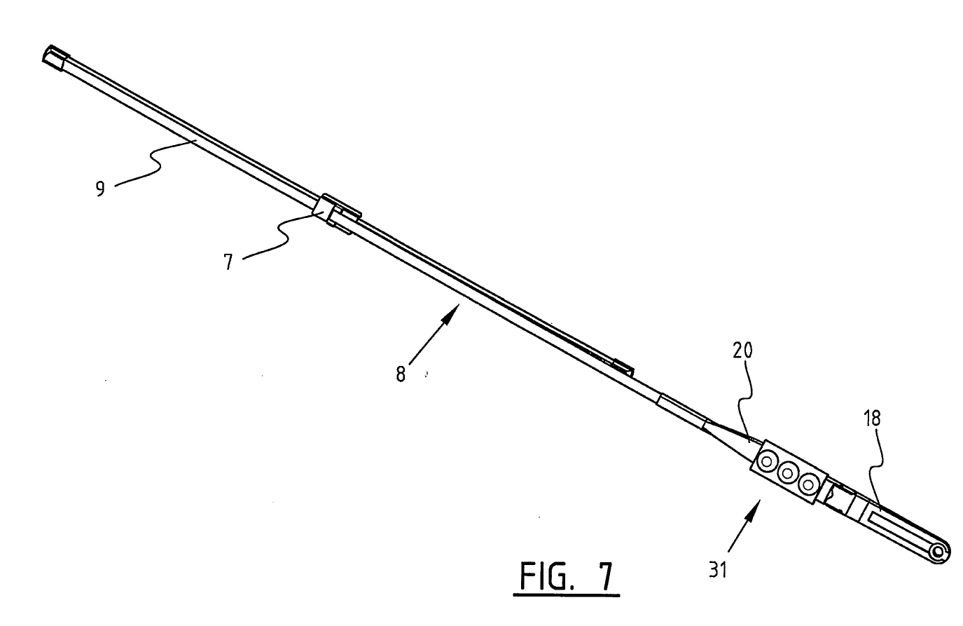

FIGS. 6 and 7 show the windscreen wiper device 1 of FIG. 1 mounted on the rear windscreen of an automobile, having a taillight 30 near the location of the shaft 19 (FIG. 6) or a taillight 31 on the arm member 20 (FIG. 7).

The invention is not restricted to the embodiment shown, but extends also to other embodiments falling within the scope of the appended claims.

1. A windscreen wiper arm to be mounted on a rear side of a vehicle comprising a mounting head mountable on a drive shaft and an arm member pivotally connected to the mounting head by means of a pivot pin, wherein said windscreen wiper arm is provided with at least one light source, provided on said mounting head near a mounting location for the drive shaft.

2. A windscreen wiper arm according to claim 1, wherein said light source is part of a taillight.

3. A windscreen wiper arm according to claim 1, wherein said light source is part of a brakelight.

4. A windscreen wiper arm according to claim 3, wherein said brakelight is a third brakelight of the vehicle.

5. A windscreen wiper arm according to claim 2, wherein at least one of said taillight and said brakelight is integrated in said windscreen wiper arm.

6. A a windscreen wiper arm according to claim 1 further comprising a windscreen wiper device.

7. A windscreen wiper arm according to claim 6, wherein said windscreen wiper device comprises an elastic, elongated carrier element, as well as an elongated wiper blade of a flexible material, which can be placed in abutment with a rear windscreen to be wiped, which wiper blade includes opposing longitudinal grooves on its longitudinal sides, in which grooves spaced-apart longitudinal strips of the carrier element are disposed, wherein neighbouring ends of said longitudinal strips are interconnected by a respective connecting piece, which windscreen wiper device also comprises a connecting device for said windscreen wiper arm according to claim 1.
